(19) United States
(12) Patent Application Publication
(10) Pub. No.: US 2002/0071672 A1
(43) Pub. Date: Jun. 13, 2002

(54) Camera with movable lens barrel

(76) Inventor: Akio Omiya, Saitama (JP)

Correspondence Address: Arnold International, P.O. BOX 585, Great Falls, VA, 22066, US

(21) Appl. No.: 10/004,498

(22) Filed: Dec. 6, 2001

(30) Foreign Application Priority Data
Dec. 11, 2000 (JP) 2000-375931

(51) Int. Cl. G03B 17/04

(52) U.S. Cl. 396/348; 396/418

(57) ABSTRACT

A camera includes a camera body. A stationary barrel is disposed in the camera body. A movable lens barrel is movable in an optical axis direction in the stationary barrel, for accommodating a zoom optical system. A lens motor is incorporated in the camera body. A taking lens gear train includes plural gears, for driving the movable lens barrel to move relative to the stationary barrel in response to rotation of the lens motor. Plural support shafts are formed integrally with the camera body, for supporting the plural gears respectively in a rotatable manner.

### BACKGROUND OF THE INVENTION

1. Field of the Invention

The present invention relates to a camera with a movable lens barrel. More particularly, the present invention relates to a camera which has a movable lens barrel and of which the number of parts can be reduced by structural simplification.

2. Description Related to the Prior Art

There is a widely used camera accommodating a zoom lens of which a zoom ratio is 2-3 times. A zooming motor or lens motor is incorporated in the camera for driving the zoom lens. It is likely that the lens motor causes the size of the camera to be considerably large. Various suggestions have been made to keep compactness of the camera even providing a space for accommodating the lens motor. For example, JP-A 2000-066284 discloses the camera in which the lens motor is disposed on an upper wall of a photo film takeup chamber, so that a dead space over the take-up chamber is reduced by utilizing the space.

JP-B 3061958 (corresponding to JP-A 6-095226) discloses an example of the camera of which a camera body has a stationary barrel formed integrally therewith, the stationary barrel having an inner helical portion. This is to reducing the number of parts to reduce the size and cost of the camera.

In a widely available type of the camera, a flash emitter is disposed on the left side because a shutter release button is located to be depressed by a user's right hand. In JP-A 2000-066284, the take-up chamber is located on the left side of the camera. The lens motor is disposed between an upper wall of the take-up chamber and the flash emitter. There is no problem if the flash emitter is stationary. If a zoom flash unit is used for changing an illuminating angle of flash light according to zooming of the zoom lens, a moving space is required for moving the flash emitter in parallel with an optical axis direction in response to zooming of the zoom lens. It is extremely difficult to keep a sufficient space for accommodating the lens motor.

According to JP-B 3061958, it is intended to reduce the manufacturing cost of the camera body by reducing the number of the parts. However, reduction of the number of parts is considerably limited if by means of only what is disclosed in the document.

### SUMMARY OF THE INVENTION

In view of the foregoing problems, an object of the present invention is to provide a camera which has a movable lens barrel and of which the number of parts can be reduced by structural simplification.

Another object of the present invention is to provide a camera which has a zoom lens and of which a size can be small even with a lens motor.

In order to achieve the above and other objects and advantages of this invention, a camera includes a camera body. A stationary barrel is disposed in the camera body. At least one movable lens barrel is movable in an optical axis direction in the stationary barrel, for accommodating a taking lens optical system. A lens motor is incorporated in the camera body. A taking lens gear train includes plural gears, for driving the movable lens barrel to move relative to the stationary barrel in response to rotation of the lens motor. Plural support shafts are formed integrally with the camera body, for supporting the plural gears respectively in a rotatable manner.

Furthermore, a cassette holder chamber is formed in the camera body, for containing a cassette shell of a photo film cassette. A take-up chamber is formed in the camera body, disposed opposite to the cassette holder chamber with respect to the stationary barrel, for taking up photo film from the cassette shell. The lens motor is disposed on a top of the take-up chamber or the cassette holder chamber.

The stationary barrel is formed integrally with the camera body.

The lens motor has a motor output shaft disposed to extend forwards in an optical axis direction relative to the camera body. The plural support shafts are formed to project from the camera body forwards in the optical axis direction, for supporting the taking lens gear train on a front side of the camera body.

The lens motor is disposed on the top of the take-up chamber. The plural support shafts are formed to project from the take-up chamber forwards in the optical axis direction.

Furthermore, a rotary encoder is provided, and includes an encoder disk, having slits arranged at a regular angular pitch, for being rotated by the lens motor. A photo sensor detects passage of the slits while the encoder disk rotates, to count rotations of the lens motor for determining a set position of the movable lens barrel.

Furthermore, a gear cover plate covers a front of the taking lens gear train, and for supporting front ends of the plural support shafts.

The plural gears include an input gear disposed higher among the plural gears, for transmitting rotation of the motor output shaft to remaining gears included in the plural gears. The encoder disk is disposed close to the input gear.

Furthermore, a zoom viewfinder unit includes at least one movable viewfinder lens, has a changeable focal length, and is adapted for observation of a photographic field. A viewfinder gear train is rotated by rotation of a portion of the taking lens gear train. A viewfinder zooming mechanism is actuated by rotation of an output gear of the viewfinder gear train, for moving the movable viewfinder lens in the optical axis direction.

The taking lens optical system includes a zoom optical system. Furthermore, a flash emitter is shiftable in the optical axis direction, for applying flash light to the photographic field. A angle changeover mechanism is actuated according to zooming of the zoom optical system, for changing an angular region within which the flash emitter emits the flash light. The flash emitter and the lens motor include a first one disposed on the top of the cassette holder chamber, and a second one disposed on the top of the take-up chamber.

The angle changeover mechanism is actuated by the viewfinder zooming mechanism, for shifting the flash emitter according to a position of the movable viewfinder lens.

The viewfinder gear train is at least partially disposed above the movable lens barrel.

The viewfinder gear train includes plural viewfinder gears for rotating about axes extending forwards in the optical axis direction from the camera body.

### BRIEF DESCRIPTION OF THE DRAWINGS

The above objects and advantages of the present invention will become more apparent from the following detailed description when read in connection with the accompanying drawings, in which:

FIG. 1 is a perspective illustrating a camera;

FIG. 2 is a rear perspective illustrating the camera;

FIG. 3 is an exploded perspective illustrating a front cover;

FIG. 4 is an exploded perspective illustrating a rear cover;

FIG. 5 is an exploded perspective illustrating a back lid and its associated elements;

FIG. 6 is a horizontal section illustrating the camera of which a wall of a take-up chamber has support shafts;

FIG. 7 is a front elevation illustrating a camera body with a taking lens gear train;

FIG. 8 is an exploded perspective illustrating the camera body with a cam plate;

FIG. 9 is an exploded perspective illustrating an AF light projector, an AF light receiver, a flash emitter and other associated elements; and

FIG. 10 is an exploded perspective illustrating a main circuit board for the camera.

### DETAILED DESCRIPTION OF THE PREFERRED EMBODIMENT(S) OF THE PRESENT INVENTION

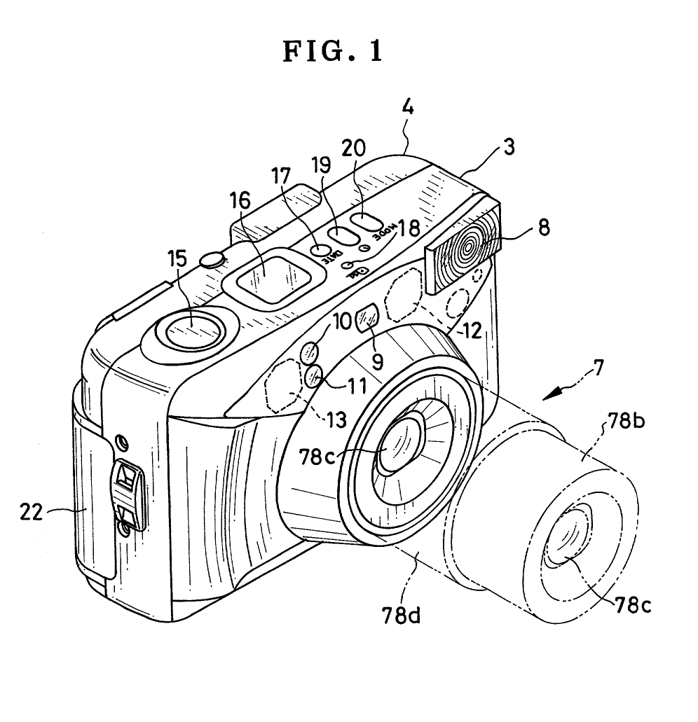

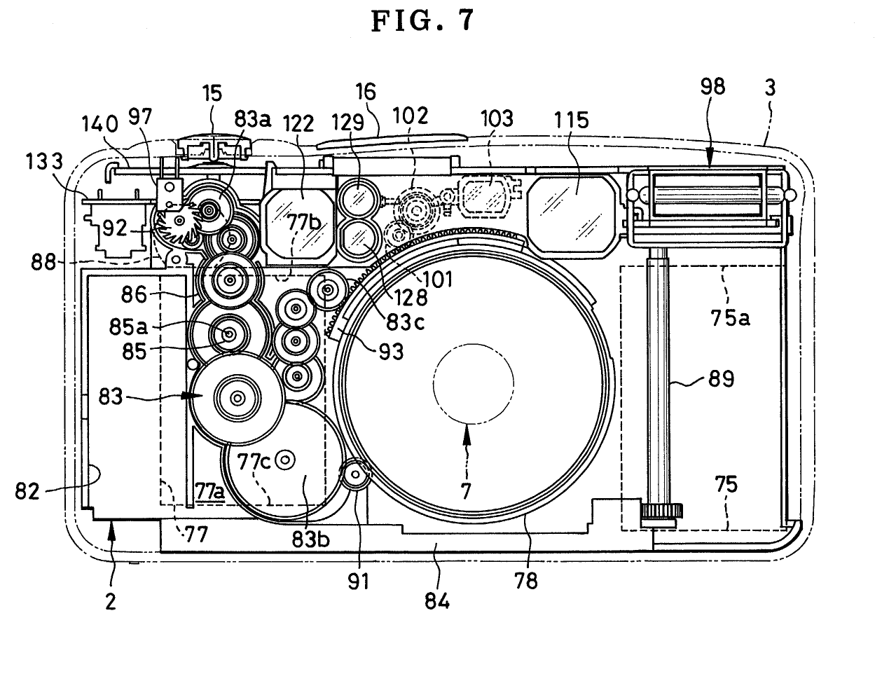

In FIG. 1, a camera of the invention is illustrated. The camera includes a camera body 2 of FIG. 7, and a front cover 3 and a rear cover 4 for covering the camera body 2.

A zoom lens 7 is incorporated in the center of the camera, and has a zoom ratio of three times. In the upper corner of the front cover 3, a light condensing front panel 8 or Fresnel lens panel is fitted, is included in a zoom flash unit, and is movable in parallel with an optical axis according to zooming of the zoom lens 7, to vary an angular region of emitting flash light. In an upper portion of the front cover 3, there are formed a viewfinder objective window 9 in a zoom viewfinder, a photometric window 10, a preflash window 11, a rangefinding light projector window 12 and a rangefinding light receiving window 13.

An upper portion of the front cover 3 is provided with a shutter release button 15, a display panel window 16, a date input button 17, a rewinding button 18, a self timer setting button 19 and a mode button 20, which are arranged from the right to the left as viewed from a user holding the camera. A battery chamber lid 22 is disposed on a lateral side of the rear cover 4 for containing a battery.

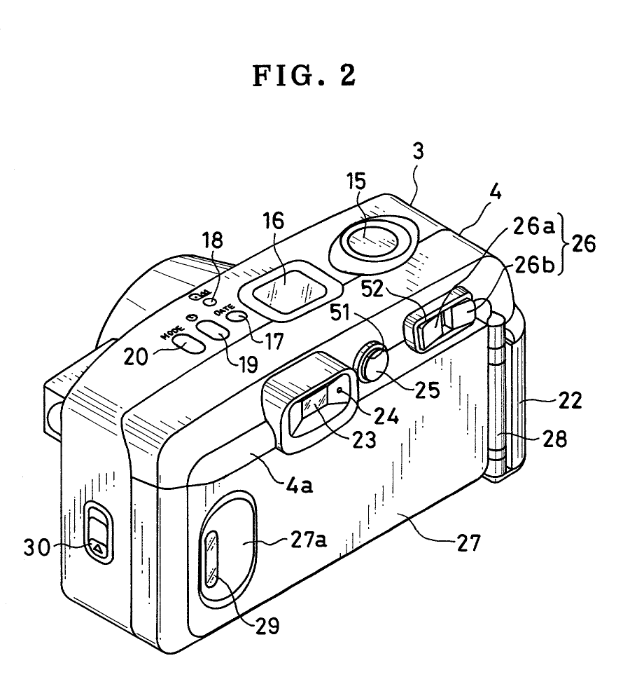

In FIG. 2, the rear of the camera is illustrated. An upper portion 4a of the rear cover 4 includes a viewfinder eyepiece window 23 in the zoom viewfinder, an AF (autofocus) checking window 24, a main switch 25 and zoom buttons 26. The zoom buttons 26 include a wide-angle button 26a and a telephoto button 26b, and are constituted by a single part depressible in a seesaw fashion. The AF checking window 24 is disposed close to the viewfinder eyepiece window 23, and emits green light when turned on. A user checks whether the AF checking window 24 illuminates even during observation through the viewfinder eyepiece window 23, so he or she can confirm the in-focus state.

A back lid 27 is secured to a lower side of the upper portion 4a of the rear cover 4 in a rotatable manner by means of a hinge 28. A recessed portion 27a is formed in a left of the back lid 27. A photo film checking window 29 is formed in the recessed portion 27a, has a transparent panel, and allows observation of a cassette shell inserted in the cassette containing chamber. A lid opener button 30 is disposed on a lateral side of the front cover 3, and is slid upwards before the back lid 27 is opened.

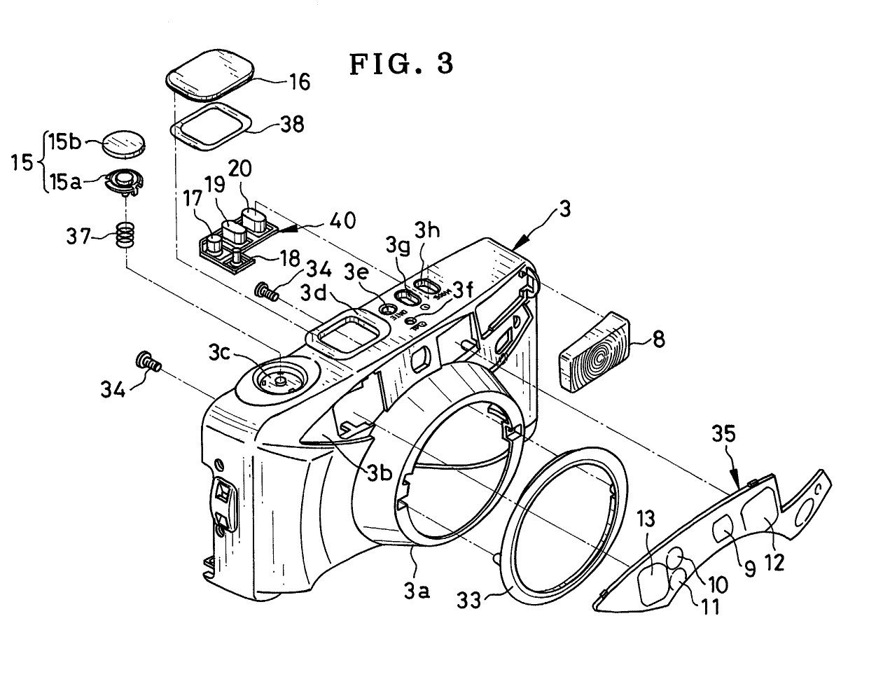

In FIG. 3, the front cover 3 is depicted in an exploded state. A lens covering portion 3a of the front cover 3 covers the periphery of the movable barrels of the zoom lens 7. A ring 33 is secured to a front edge of the lens covering portion 3a by means of two screws 34. A front window panel 35 of a single piece is formed to include the viewfinder objective window 9, the photometric window 10, the preflash window 11, the rangefinding light projector window 12 and the rangefinding light receiving window 13.

In the front window panel 35, portions in front of the viewfinder objective window 9, the photometric window 10 and the preflash window 11 are transparent. Portions of the front window panel 35 in front of the rangefinding light projector window 12 and the rangefinding light receiving window 13 are thinly gray and transparent, namely, are transparent with lower transmittance. Portion of the front window panel 35 except for the windows are opaque and black. A receiving recess 3b is formed in the front cover 3. The front window panel 35 is secured to the inside of the receiving recess 3b by engagement of hooks.

The shutter release button 15 is constituted by a button core 15a and a button cap 15b for covering the button core 15a. The shutter release button 15 is fitted in a recess 3c formed in an upper wall of the front cover 3. A coil spring 37 is disposed between the recess 3c and the button core 15a, and biases the shutter release button 15 upwards, or in a direction against depression.

The display panel window 16 is a transparent plate of resin in a quadrilateral shape, and is attached to the inside of a recess 3d by use of a double-sided tape 38. A multi-button rubber part 40 is a single piece of synthetic rubber or elastomer, and includes the date, rewinding, timer and mode buttons 17-20 inserted in holes 3e, 3f, 3g and 3h in the front cover 3. Conductive rubber segments are formed with or attached to the rear of the date, rewinding, timer and mode buttons 17-20. When each of the date, rewinding, timer and mode buttons 17-20 is depressed and deformed resiliently, one of the conductive rubber segments switches on the printed contact points in the printed circuit board.

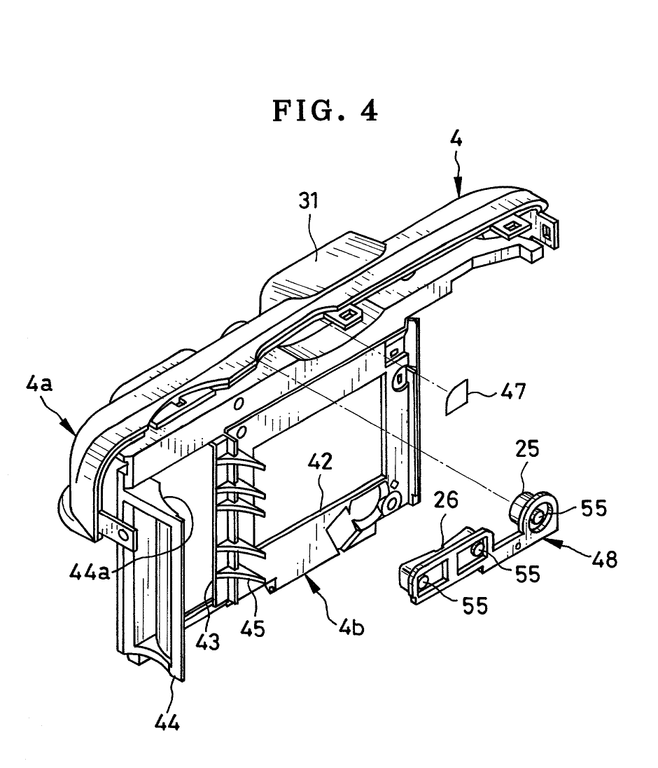

In FIG. 4, the inside of the rear cover 4 is illustrated. A photo film path plate portion 4b is included in the rear cover 4, formed to project from a lower edge of the upper portion 4a. An exposure aperture 42 is formed in the photo film path plate portion 4b, and defines a region of exposing the photo film. A quadrilateral opening 43 is formed in the rear cover 4 beside the exposure aperture 42, and causes the photo film to enter a photo film take-up chamber.

An insertion portion 44 is formed with one edge of the quadrilateral opening 43 for being inserted in the take-up chamber. An arc-shaped guide face 44a of the insertion portion 44 is so curved as to guide the photo film into the take-up chamber. Plural guide ridges 45 project from an inner face along one edge of the quadrilateral opening 43. The guide ridges 45 are five ridges in the present embodiment.

A translucent resin plate 47 is attached to an inner surface of the upper portion 4a behind the AF checking window 24. The main switch 25 and the zoom buttons 26 are constituted by a multi-button rubber part 48 as a single piece of synthetic rubber or elastomer. See FIG. 4. A circular opening 51 and a quadrilateral opening 52 are formed in the upper portion 4a. See FIG. 2. The multi-button rubber part 48 is secured inside the upper portion 4a to protrude the main switch 25 and the zoom buttons 26 through the circular opening 51 and the quadrilateral opening 52.

Conductive rubber segments 55 are formed with or attached to the rear of the multi-button rubber part 48 at the main switch 25 and the zoom buttons 26. Each one of the conductive rubber segments 55 switches on the printed contact points in the printed circuit board, so the camera is initially powered, and the zoom lens 7 is zoomed.

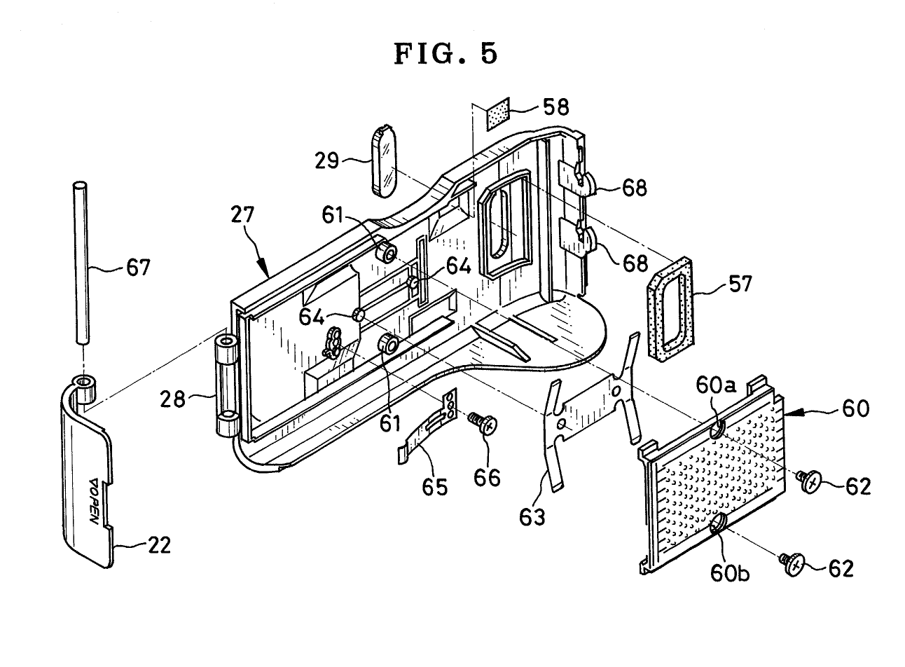

In FIG. 5, the inside of the back lid 27 is illustrated. A light-shielding pad 57 of a porous material like a sponge has a quadrilateral frame shape, and is attached to a portion inside positions where the photo film checking window 29 is disposed. An anti-reflection paper 58 is attached to a position beside the light-shielding pad 57, is constituted by black paper with pile threads or other black thin porous members, and suppresses reflection of light emitted by an LED (light-emitting diode) at the time of recording a date.

A photo film pressure plate 60 is disposed in the center of the back lid 27. Circular holes 60a and 60b are formed in the photo film pressure plate 60 and disposed close to its upper and loser edges. Two bosses 61 project from the inside of the back lid 27, are inserted in the circular holes 60a and 60b. Screws 62 through the circular holes 60a and 60b are fastened to the bosses 61, to secure the photo film pressure plate 60. The photo film pressure plate 60 is movable in the thickness direction of the back lid 27 in a range of approximately 0.5 mm. A plate spring 63 is disposed between the back lid 27 and the photo film pressure plate 60. Two pins 64 position the plate spring 63, which biases the photo film pressure plate 60 in a direction away from the back lid 27.

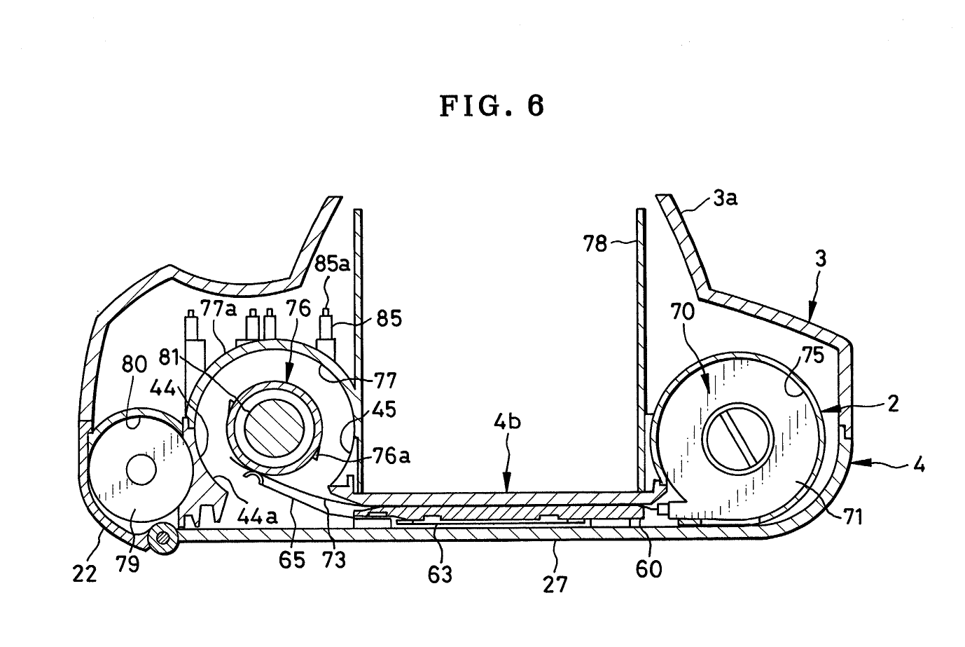

A regulation spring 65 has one end, which a screw 66 fixes to an inner wall of the back lid 27. In the camera, a photo film cassette 70 is inserted, and includes a roll of a photo film 73. When the photo film 73 is unwound, the regulation spring 65 pushes the photo film 73 toward a winder shaft 76. See FIG. 6. At an initial step of photo film winding, the regulation spring 65 makes it easy to engage claws 76a of the winder shaft 76 with perforations in a photo film leader. Reliability of operation of loading of the photo film cassette 70 according the “drop-in-loading” system can be sufficient. Note that the camera of the present embodiment has a pre-winding system, according to which the entirety of the photo film 73 is initially advanced from a cassette shell 71 and wound about a take-up shaft before starting an exposure to a first frame. At each time that one frame is exposed, a portion with the exposed frame is wound back into the cassette shell 71. Thus the pre-winding system is advantageous in that the photo film 73 will not be fogged by ambient light even if the back lid 27 should open upon an accidental manual opening operation.

A hinge rod 67 is inserted in the hinges 28 at an end of the back lid 27, and keeps the back lid 27 movable pivotally relative to the camera body 2. The hinge rod 67 also supports the battery chamber lid 22, and keeps the same openable from the camera body 2. Two locking hooks 68 are formed integrally with the back lid 27, and lock the back lid 27 in the closed position on the camera body 2.

In FIG. 6, the camera body 2 includes a cassette holder chamber 75, a take-up chamber 77, a stationary barrel 78 and a battery chamber 80. The cassette holder chamber 75 contains the cassette shell 71 of the photo film cassette 70. The take-up chamber 77 takes up the photo film 73 from the cassette shell 71 and accommodates a roll of the photo film 73 in a form wound about the winder shaft 76. The stationary barrel 78 is formed between the cassette holder chamber 75 and the take-up chamber 77, and constitutes an outermost element accommodating the movable barrels of the zoom lens 7. The battery chamber 80 is formed with an outer wall of the take-up chamber 77, and contains a battery 79. As the stationary barrel 78 is included in a single piece of the base portion of the camera body 2, the number of parts and the number of manufacturing steps can be reduced considerably. Also, the stationary barrel 78 can have a high strength. Precision of positioning the stationary barrel 78 with the camera body 2 can be kept high in comparison with a conventional type of the stationary barrel 78 subsequently fixed to the camera body 2. Note that a photo film advancing motor 81 is incorporated in the winder shaft 76.

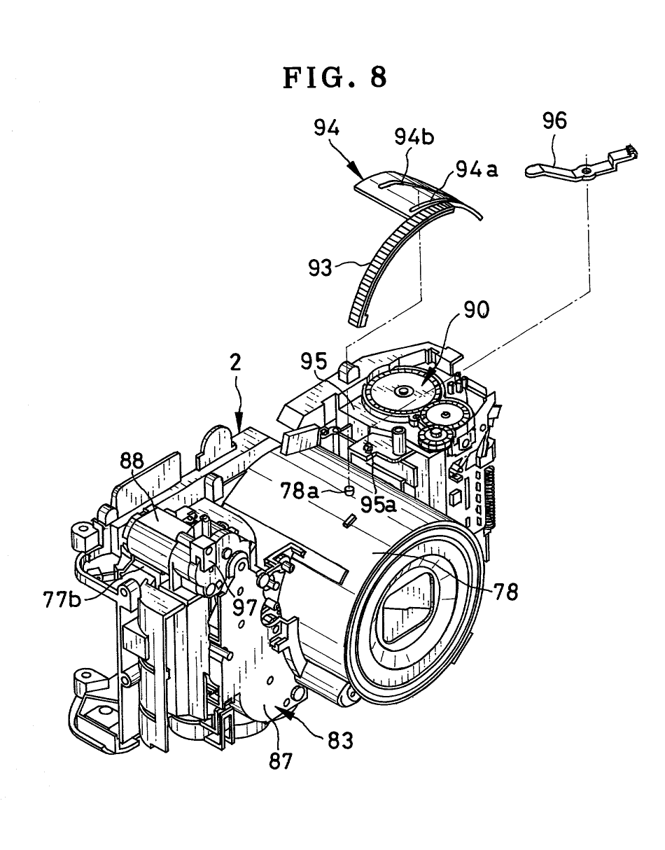

A front face 77a of the take-up chamber 77 has support shafts 85 formed integrally therewith. A taking lens gear train 83 includes gears, which are actuated to drive the movable barrels of the zoom lens 7. See FIGS. 7 and 8. There are ridges or projections 86 formed to project from the front face 77a of the take-up chamber 77 toward the front behind the periphery of the gears or their lower face. Note that the ridges or projections 86 are eliminated from FIG. 6 for simplification, but are depicted in FIG. 7. Some of the ridges or projections 86 that are disposed beside the gears protect the taking lens gear train 83 in cooperation with a gear cover plate 87 which covers the front of the taking lens gear train 83. See FIG. 8. The others of the ridges or projections 86 that are directly behind the gears support the rear of the rear, and prevent the gears from being axially offset. Positioning front end pins 85a protrude from respective ends of the support shafts 85, and are inserted in receiving holes formed in the gear cover plate 87.

In FIGS. 7 and 8, a lens motor 88 is secured to an upper wall 77b of the take-up chamber 77, and drives the taking lens gear train 83. A dead space directly above the take-up chamber 77 can be utilized with the lens motor 88, to reduce a size and cost of the camera body 2. Note that a main capacitor (not shown) is included in elements for flash emission. A capacitor chamber 82 is disposed beside the taking lens gear train 83, and contains the main capacitor.

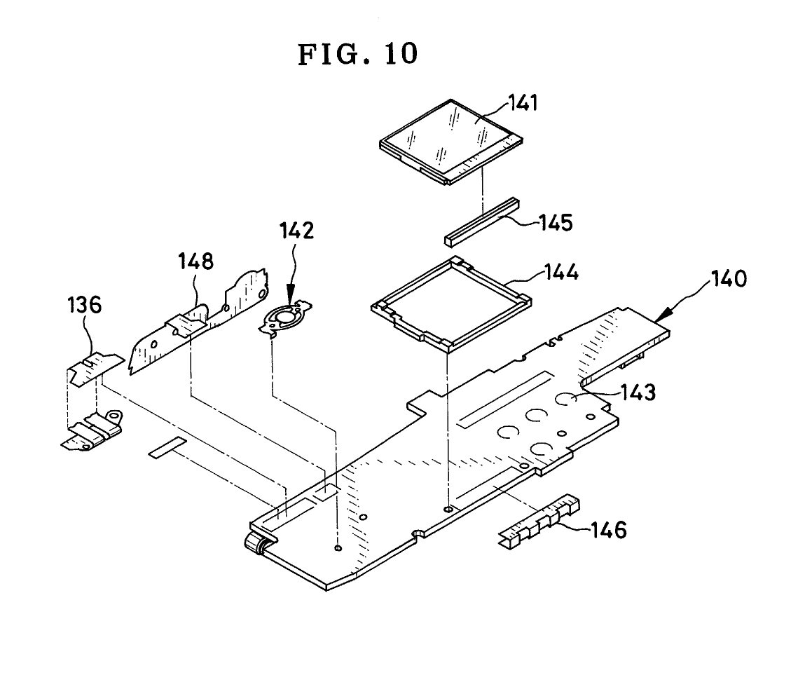

A pinion is fixed to an output shaft of the lens motor 88. An input gear 83a of the taking lens gear train 83 is meshed with the pinion. Also, another gear is meshed with the pinion, the gear being formed integrally with a pulse disk or encoder disk 92 in a rotary encoder. A photo interrupter 97 or photo sensor in the rotary encoder is disposed so that the encoder disk 92 lies between projecting and receiving elements of the photo interrupter 97. When the encoder disk 92 rotates, the photo interrupter 97 outputs a train of barrel moving pulses in synchronism with movement of the movable barrels of the zoom lens 7. A main circuit board 140, which is illustrated in FIG. 10, has a CPU, which is supplied with the barrel moving pulses. In response with the barrel moving pulses, the CPU controls the zoom lens 7 for collapsing, zooming and focusing. To focus the zoom lens 7, the shutter release button 15 is halfway depressed to rotate the lens motor 88 to a small extent backwards, namely in a direction opposite to the zooming.

A lower wall 77c defines a lower end of the take-up chamber 77. A lower gear train 84 is disposed under the take-up chamber 77, extends from the lower wall 77c via the underside of the photo film path to the vicinity of the cassette holder chamber 75, and is driven by the photo film advancing motor 81. Near to the lower gear train 84, a gear-formed rod 89 extends, and includes end gears formed with respectively rod ends. An upper gear train 90 is disposed on an upper wall 75a of the cassette holder chamber 75. An output gear included in the lower gear train 84 transmits rotation to the gear-formed rod 89 and then to the upper gear train 90, which drives a spool drive shaft (not shown) projecting into the cassette holder chamber 75 from the upper wall 75a.

The taking lens gear train 83 extends in a V shape. A gear 83b of a larger size included in the taking lens gear train 83 is located in the lowest position. A transmission gear 91 is meshed with the gear 83b, and operates for zooming and focusing of the zoom lens 7. The transmission gear 91 has an elongated shape extending in parallel with an axis of the stationary barrel 78. A gear portion of a first movable barrel in the stationary barrel 78 is meshed with the transmission gear 91.

In the present embodiment, the zoom lens 7 is constituted by the stationary barrel 78, a first movable barrel 78d, a second movable barrel 78b and a zoom optical system 78c. The first movable barrel 78d is coupled with the inside of the stationary barrel 78. The second movable barrel 78b is coupled with the inside of the first movable barrel 78d. The construction of the zoom lens 7 is well-known to those skilled in the art. The following is a brief description of the zoom lens 7.

A first female helicoid is formed inside the stationary barrel 78. A cutout is formed in the stationary barrel 78 for receiving entry of a portion of the transmission gear 91. A plurality of projections are formed with the rear end of an outside of the first movable barrel 78d, and arranged regularly. Those projections constitute a first male helicoid engaged with the first female helicoid of the stationary barrel 78 helically. Also, a gear portion is formed with the rear end of the outside of the first movable barrel 78d, and is engaged with the transmission gear 91 through the cutout formed in the stationary barrel 78. A second female helicoid is formed inside the first movable barrel 78d.

A second male helicoid is formed with the rear end of the outside of the second movable barrel 78b, and is engaged with the second female helicoid of the first movable barrel 78d. The zoom optical system 78c is accommodated in the second movable barrel 78b. A cam is disposed in the second movable barrel 78b. The zoom optical system 78c is caused by the cam to move in the optical axis direction, for control of the step zooming and focusing of the zoom lens 7.

When the zoom buttons 26 are operated, the lens motor 88 rotates. The rotation is transmitted by the transmission gear 91 to the first movable barrel 78d, which rotates responsively. The first movable barrel 78d, because helically coupled with the stationary barrel 78, moves to protrude from the front of the stationary barrel 78 at the same time as rotation about its optical axis. This helical movement of the first movable barrel 78d causes the second movable barrel 78b to move forwards in a rectilinear manner relative to the stationary barrel 78.

When the zoom lens 7 comes to have a magnification desired by a user, he or she leaves a finger from the zoom buttons 26. The lens motor 88 is stopped in response to coming up of the magnification to that of an Nth zoom step which is a succeeding one of plural preset zoom steps. The zoom optical system 78c is set in a home position which is assigned to the Nth zoom step. The zoom lens 7, at the time set in the home position, is focused at a near distance. Also, in response to zooming of the zoom lens 7, a viewfinder magnification in the zoom viewfinder is changed, and the angular region of flash of the zoom flash unit is changed. The lens motor 88 is rotated backwards, to move backwards the first and second movable barrels 78d and 78b.

When the shutter release button 15 is halfway depressed, the autofocus device is caused to measure an object distance. According to the object distance, the lens motor 88 rotates. The rotation causes the zoom optical system 78c to move for the focusing in keeping the magnification at the Nth zoom step. This is a technique of the step zoom widely used typically in a compact camera or the like. When the shutter release button 15 is depressed fully, the shutter device is actuated to take an exposure. After this, the lens motor 88 rotates backwards, to return the zoom optical system 78c to the home position determined for the Nth zoom step.

A viewfinder gear 83c in the taking lens gear train 83 is located on the left side as an output gear of a viewfinder gear train as a branch from the gear 83b. An transmission gear tooth train 93 in an arc shape for zooming the viewfinder is engaged with the viewfinder gear 83c. A cam plate 94 is formed with an end of the transmission gear tooth train 93, and has a shape curved in an arc form. Two cam grooves 94a and 94b are formed in the cam plate 94.

A projection 78a projects from the stationary barrel 78, and is inserted in the cam groove 94a. When the viewfinder gear 83c rotates, the transmission gear tooth train 93 and the cam plate 94 move on the outside of the stationary barrel 78. A flash changeover lever 96 in a zoom flash unit has one end engaged with the cam groove 94b. When the cam plate 94 moves, the flash changeover lever 96 rotates, so a flash emitter 98 in the zoom flash unit is moved in the optical axis direction according to zooming of the zoom lens 7, to change a region of distribution of flash light. Note that a plate 95 is formed integrally with an upper wall of the cassette holder chamber 75. A projection or pin 95a projects from the plate 95, and keeps the flash changeover lever 96 rotatable thereabout.

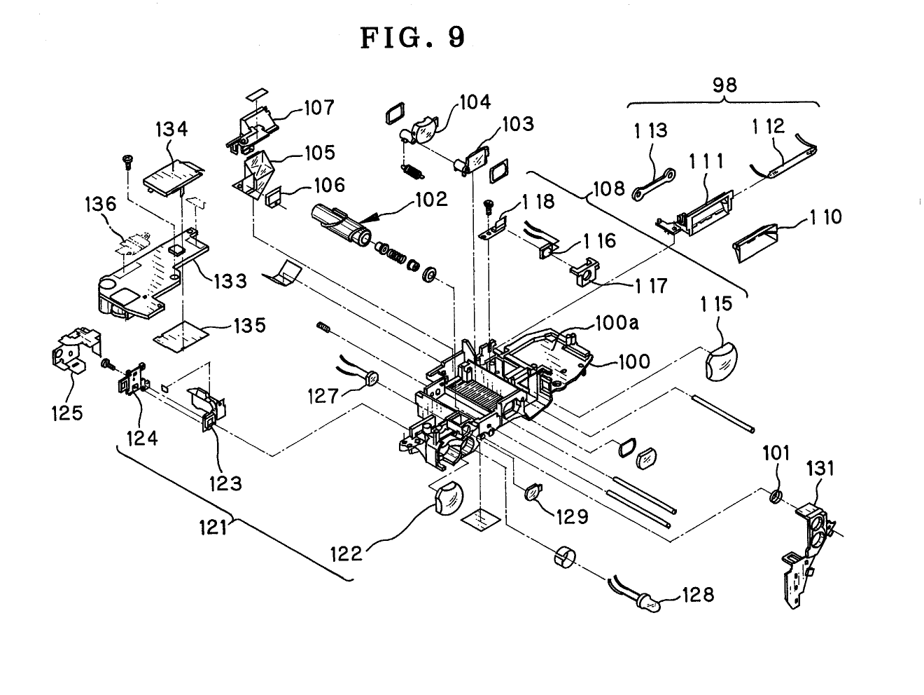

In FIG. 9, an AF (autofocus) holder or finder/flash bolder 100 supports a gear 101. The transmission gear tooth train 93 is meshed with the gear 101, so as to rotate a viewfinder zooming cam 102 which is meshed with the gear 101. The AF holder 100 is disposed to extend above the cassette holder chamber 75, the stationary barrel 78 and the take-up chamber 77, and covers the upper gear train 90, the cam plate 94 and the lens motor 88.

In FIG. 9, the AF holder or finder/flash holder 100 is a unified component supporting the zoom flash unit, the zoom viewfinder and the like. Movable viewfinder lenses 103 and 104 are engaged with the viewfinder zooming cam 102, and constitutes the zoom viewfinder. When the viewfinder zooming cam 102 rotates, positions of the movable viewfinder lenses 103 and 104 change with reference to the optical axis direction, to provide a view field according to a zoomed position of the zoom lens 7.

An eyepiece prism 105 is disposed behind the movable viewfinder lens 104, and changes an orientation of an observed image into a horizontally and vertically suitable orientation without being upside down and without being a mirror image. A view field frame plate 106 is attached to an end face of the eyepiece prism 105, and indicates a view field frame, a rangefinding region and the like at the time of the close-up photography. A prism cover 107 is fitted on the eyepiece prism 105 for shielding ambient light.

An AF (autofocus) light projector 108 is disposed behind the rangefinding light projector window 12. Also, a plate portion 10a is included in the AF holder or finder/flash holder 100. Beside the AF light projector 108, the flash emitter 98 is supported on the plate portion 10a in a manner movable in parallel with the optical axis. Note that the flash emitter 98 is disposed directly above the cassette holder chamber 75. The upper gear train 90 and the plate portion 10a are disposed between the flash emitter 98 and the cassette holder chamber 75.

The flash emitter 98 includes a reflector 110, a reflector holder 111, a xenon discharge tube 112 and a silicone band 113. The reflector holder 111 supports the reflector 110. The xenon discharge tube 112 is inserted in the reflector holder 111. The silicone band 113 fastens the xenon discharge tube 112 to the reflector holder 111.

The AF light projector 108 includes a projector lens 115, an infrared LED (light-emitting diode) 116, an LED holder 117 and a fastening plate 118. The infrared LED 116 is disposed behind the projector lens 115. The LED holder 117 supports the infrared LED 116. The fastening plate 118 positions the infrared LED 116. An AF (autofocus) light receiver 121 is combined with the AF light projector 108, and includes a light receiving lens 122, a photoreceptor element 123 and a photoreceptor holder 124. The light receiving lens 122 is disposed behind the rangefinding light receiving window 13. The photoreceptor element 123 is disposed behind the light receiving lens 122 and receives infrared rays reflected by an object. The photoreceptor holder 124 holds the photoreceptor element 123. A shielding plate 125 shields the photoreceptor element 123 and the photoreceptor holder 124 from ambient light.

A photometric photoreceptor element 127 and a preflash lamp 128 are disposed on the AF holder or finder/flash holder 100 and between the AF light receiver 121 and the viewfinder zooming cam 102. The photometric photoreceptor element 127 is behind the photometric window 10, and the preflash lamp 128 behind the preflash window 11. The preflash lamp 128 is driven for illumination with blinks shortly before photography with flash, to prevent a red-eye phenomenon. Also, a light receiving lens 129 is disposed in front of the photometric photoreceptor element 127. A gear support plate 131 is secured to a front portion of the AF holder 100, and supports the gear 101, the preflash lamp 128 and the light receiving lens 129. A lower portion of the gear support plate 131 also operates to protect the viewfinder gear 83c and some other portions of the taking lens gear train 83.

An AF (autofocus) circuit board 133 is disposed above the AF light receiver 121. See FIG. 7. A circuit shielding plate 134 is disposed above the AF circuit board 133, and has a flat box shape. A shielding sheet 135 is disposed under the AF circuit board 133 so that the AF circuit board 133 lies between the circuit shielding plate 134 and the shielding sheet 135. A flexible wiring board 136 is connected to an upper corner of the AF circuit board 133 by soldering for connection to the main circuit board 140. See FIGS. 7 and 10. Furthermore, the AF circuit board 133 includes a flash circuit in addition to the AF circuit. Among elements of the flash circuit, a transformer and the main capacitor in the capacitor chamber 82 are connected to a lower side of the AF circuit board 133.

In FIG. 10, the main circuit board 140 is illustrated. An LCD (liquid crystal display) panel 141 is connected to an upper portion of the main circuit board 140, and positioned through the display panel window 16 in an externally observable state. A contact segment 142 is connected to the upper portion of the main circuit board 140, constitutes a release switch, and is depressible by an inner portion of the shutter release button 15. Also, the main circuit board 140 has plural printed contact points 143, which are suitably switched on by operation of each of various operation buttons. A portion of the main circuit board 140 close to the contact segment 142 has a printed contact point which is switched on by contact with the contact segment 142 depressed by the shutter release button 15, the printed contact point constituting the release switch in combination with the contact segment 142.

A resin frame 144 of a quadrilateral shape is disposed on an upper surface of the main circuit board 140, and includes projections projecting downwards. The projections are inserted in holes in the main circuit board 140, and position the resin frame 144 exactly on the main circuit board 140. One edge of the resin frame 144 is positioned along a front edge of the main circuit board 140. A zebra connector 145 is positioned on the front edge of the resin frame 144. Also, the LCD panel 141 is fitted in the resin frame 144. A clip 146 squeezes and fixedly positions a combination of the main circuit board 140, the resin frame 144, the zebra connector 145 and the LCD panel 141. Thus, the printed contact points of the main circuit board 140 are electrically connected with the LCD panel 141 by means of the zebra connector 145.

To a corner portion of the main circuit board 140, a flexible wiring board 148 is connected by means of soldering, in addition to the flexible wiring board 136. Printed contact points are formed in the flexible wiring board 148 for being switched on by the main switch 25 and the zoom buttons 26. Also, a CPU is connected to a lower portion of the main circuit board 140, for controlling relevant elements of the camera. A motor driving IC is connected to the lower portion of the main circuit board 140, for driving and controlling the lens motor 88 and the photo film advancing motor 81. A booster circuit is connected to the lower portion of the main circuit board 140, for boosting voltage supplied by the battery.

This being so, the stationary barrel 78 and the support shafts 85 in the camera are formed integrally with the camera body 2 in relation to the zoom lens 7 and the taking lens gear train 83. The number of parts and the number of steps of manufacturing can be reduced considerably. Also, the strength of the stationary barrel 78 can be raised. Precision in positioning between the stationary barrel 78 and the camera body 2 can be raised. Also, the lens motor 88 is disposed on the upper wall 77b of the take-up chamber 77. Accordingly, spaces in the camera can be utilized effectively without being dead, to reduce the size of the camera.

In the above embodiment, the taking lens optical system is the zoom lens 7. However, the taking lens optical system may have a fixed focus. In the above-described camera, the take-up chamber 77 is disposed on the left side as viewed from a user. The cassette holder chamber 75 is disposed on the right side. However, the take-up chamber 77 and the cassette holder chamber 75 may be disposed in an opposite manner. In this structure, the flash emitter 98 of the zoom flash unit is disposed directly at the upper wall 77b of the take-up chamber 77. The lens motor 88 is disposed at the upper wall 75a of the cassette holder chamber 75.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A camera comprising:
a camera body;
a stationary barrel disposed in said camera body;
at least one movable lens barrel, movable in an optical axis direction in said stationary barrel, for accommodating a taking lens optical system;
a lens motor incorporated in said camera body;
a lens moving mechanism for moving said movable lens barrel in said optical axis direction;
a taking lens gear train, including plural gears, for moving said movable lens barrel relative to said stationary barrel by transmitting rotation of said lens motor to said lens moving mechanism; and
plural support shafts, formed integrally with said camera body, for supporting said plural gears respectively in a rotatable manner.

2. A camera as defined in claim 1, wherein said stationary barrel is formed integrally with said camera body.

3. A camera as defined in claim 2, further comprising:
a cassette holder chamber, formed in said camera body, for containing a cassette;
a take-up chamber, formed in said camera body, disposed opposite to said cassette holder chamber with respect to said stationary barrel, for taking up photo film from said cassette;
wherein said lens motor is disposed on a top of said take-up chamber or said cassette holder chamber.

4. A camera as defined in claim 3, wherein said lens motor has a motor output shaft disposed to extend in said optical axis direction relative to said camera body;
said plural support shafts project in said optical axis direction, and said plural gears are arranged upwards or downwards on a front side of said camera body.

5. A camera as defined in claim 4, wherein said lens motor is disposed on said top of said take-up chamber;
said plural support shafts are disposed outside said take-up chamber.

6. A camera as defined in claim 5, further comprising a rotary encoder, including:
an encoder disk, having slits arranged at a regular angular pitch, for being rotated by said lens motor; and
a photo sensor for detecting passage of said slits while said encoder disk rotates, to count rotations of said lens motor for determining a set position of said movable lens barrel.

7. A camera as defined in claim 6, further comprising a gear cover plate for covering a front of said taking lens gear train, and for supporting front ends of said plural support shafts.

8. A camera as defined in claim 2, wherein said taking lens optical system includes a zoom optical system;
further comprising:
a flash emitter for applying flash light to said photographic field;
an angle changeover mechanism, actuated according to zooming of said zoom optical system, for changing an angular region within which said flash emitter emits said flash light;
said flash emitter and said lens motor include a first one disposed on said top of said cassette holder chamber, and a second one disposed on said top of said take-up chamber.

9. A camera as defined in claim 8, further comprising:
a zoom viewfinder unit, including at least one movable viewfinder lens, having a changeable focal length, and adapted for observation of a photographic field;
a viewfinder gear train for being rotated by said taking lens gear train; and
a viewfinder zooming mechanism, actuated by rotation of said viewfinder gear train, for moving said movable viewfinder lens in said optical axis direction.

10. A camera as defined in claim 9, wherein said angle changeover mechanism is actuated by said viewfinder zooming mechanism, for shifting said flash emitter in said optical axis direction according to a position of said movable viewfinder lens, to change a distance from a Fresnel lens.

11. A camera as defined in claim 10, wherein said angle changeover mechanism includes:
an arc-shaped gear disposed on a periphery of said stationary barrel in a rotationally movable manner; and
a cam mechanism, actuated by said arc-shaped gear, for shifting said flash emitter.

12. A camera as defined in claim 11, wherein said viewfinder gear train includes plural viewfinder gears arranged on a front side of said camera body.
